(19) United States
(12) Patent Application Publication
(10) Pub. No.: US 2025/0103851 A1
(43) Pub. Date: Mar. 27, 2025

(54) EXPERT FEEDBACK LOOP FOR RESOLVING AMBIGUITY

(71) Applicant: Intuit, Inc., Mountain View, CA (US)

(72) Inventors: Byron TANG, Mountain View, CA (US); Narendra SOHANLAL, San Diego, CA (US); Sushma KIRAN, San Jose, CA (US); Bilal RIZVI, Fremont, CA (US); Coreen Ann SOLANO, Reno, NV (US); Atanu ROY, Dublin, CA (US); Lei CHEN, Princeton Junction, NJ (US); Aditi DAS, Fremont, CA (US); Hyesoo YOUN, Kensington, CA (US); Wei WANG, Cupertino, CA (US)

(21) Appl. No.: 18/372,660

(22) Filed: Sep. 25, 2023

(51) Int. Cl. G06N 3/042; G06N 3/0455

(52) U.S. Cl. CPC G06N 3/042; G06N 3/0455

(57) ABSTRACT

Certain aspects of the disclosure provide systems and methods for resolving ambiguities encountered by a decision machine learning (ML) model during processing of input data. For example, a method may include identifying an ambiguity during decision processing of first input data by a decision ML model; conveying the ambiguity to an expert agent for evaluation; receiving, by an LLM, feedback regarding the ambiguity from the expert agent; determining, by the LLM, that the feedback, received from the expert agent, resolves the ambiguity; generating second input data by the LLM, the second input data having the first input data and the feedback determined to resolve the ambiguity; processing the second input data by the decision ML model to generate a decision based on processing of the second input data; and outputting, by the LLM, the decision received from the ML model.

### BACKGROUND

### Field

Aspects of the present disclosure relate to decision processing using machine learning models. More specifically, aspects of the present disclosure relate to ambiguity resolution in decision processing using machine learning models.

### Description of Related Art

Machine learning models are well adapted to processing large quantities of data to find patterns of interest. Some data processing tasks that machine learning models excel at include cyber-security breach detection, fraud detection, investment trends, etc. However, outlier or ambiguous data can confuse the machine learning model. Ambiguous data may prevent a machine learning model from arriving at a definitive decision. As a result, human intervention, by an expert, may be necessary to overcome the ambiguous data. However, the expert is typically not aware of the progress made by the machine learning model in evaluating the data. Moreover, feedback provided by the expert to the machine learning model may not provide adequate information for the ambiguous data to be resolved by the machine learning model.

### SUMMARY

Certain aspects provide a method including identifying an ambiguity during decision processing of first input data by a decision machine learning (ML) model. The method may also include conveying the ambiguity to an expert agent for evaluation. The method may furthermore include receiving, by a large language model (LLM), feedback regarding the ambiguity from the expert agent. The method may in addition include determining, by the LLM, that the feedback, received from the expert agent, resolves the ambiguity. The method may moreover include generating second input data by the LLM, the second input data having the first input data and the feedback determined to resolve the ambiguity. The method may also include processing the second input data by the decision ML model to generate a decision based on processing of the second input data. The method may furthermore include outputting, by the LLM, the decision received from the ML model. Other embodiments of this aspect include corresponding computer systems, apparatus, and computer programs recorded on one or more computer storage devices, each configured to perform the actions of the methods.

Certain aspects provide a processing system including a memory having computer-executable instructions and a processor configured to execute the computer-executable instructions and cause the processing system to: identify an ambiguity during decision processing of first input data by a decision machine learning (ML) model; convey the ambiguity to an expert agent for evaluation; receive, by a large language model (LLM), feedback regarding the ambiguity from the expert agent; determine, by the LLM, that the feedback, received from the expert agent, resolves the ambiguity; generate second input data by the LLM, the second input data having the first input data and the feedback determined to resolve the ambiguity; process the second input data by the decision ML model to generate a decision based on processing of the second input data; and output, by the LLM, the decision received from the ML model. Other embodiments of this aspect include corresponding computer systems, apparatus, and computer programs recorded on one or more computer storage devices, each configured to perform the actions of the methods.

Certain aspects provide a method for providing a risk assessment of customer activity. For example, a method for providing a risk assessment of customer activity may include receiving customer activity as first input data. The method may also include evaluating the first input data by the decision ML model. The method may furthermore include identifying, by the decision ML model, an ambiguity preventing the decision ML model from satisfying a confidence threshold condition. The method may in addition include transmitting information relating to the ambiguity to an expert agent. The method may moreover include providing, to the decision ML model, second input data determined to resolve the ambiguity from the expert agent. The method may also include applying, by the decision ML model, the second input data determined to resolve the ambiguity to the first input data to complete evaluation of the first input data. The method may furthermore include outputting the completed evaluation of the first input data as a risk assessment decision. Other embodiments of this aspect include corresponding computer systems, apparatus, and computer programs recorded on one or more computer storage devices, each configured to perform the actions of the methods.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 illustrates a decision machine learning model-based system configured to perform aspects of the present disclosure.

FIG. 2 illustrates a block representation of an aspect of the present disclosure.

FIG. 3 and FIG. 4 illustrate a flow diagram representing a method in accordance with aspects of the present disclosure.

FIG. 5 illustrates a flow diagram representing another method in accordance with aspects of the present disclosure.

FIG. 6 illustrates a flow diagram represent a method of a use case in accordance with aspects of the present disclosure.

FIG. 7 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for resolving ambiguities identified by a decision machine learning (ML) model.

Decision ML models can be used for processing data to provide a binary (e.g., Yes/No) risk assessment for activities ranging from cybersecurity to credit card fraud. However, some data that the decision ML model may process to arrive at a risk assessment may not neatly match the training scenarios, giving rise to an ambiguity. Anomalies can prevent the decision ML model from generating an accurate decision. An ambiguity occurs when data is encountered that in some circumstances could signify a high risk, for example, but under other conditions the same data could indicate a low risk situation. Ambiguous data is data that results in an ambiguity.

When a decision ML model detects ambiguous data, human intervention from an expert in the field (also referred herein as an “expert agent”) may be necessary to resolve the ambiguity. When an expert agent is called upon to resolve the ambiguity, the expert agent may receive the particular data causing the ambiguity from the decision ML model, but generally very little additional information is provided. The expert agent may not be aware of the processing already performed on the input date by the decision ML model up to the point where the ambiguity was encountered, nor even the assessment by the decision ML model up to that point. Consequently, the expert agent is left having to reevaluate all the data of the case, not just the ambiguous data in order to render an accurate analysis (also referred to herein as “feedback” or “expert insight”) of the ambiguous data. Moreover, the expert agent may not have properly or fully addressed the issues causing the data to be considered ambiguous by the decision ML model. Thus, the evaluation of the ambiguous data by the expert agent still may not allow the decision ML model to continue the processing of the data to arrive at a final decision.

Aspects of the present disclosure provide for a decision ML model that is trained to provide details of the preceding processing, preliminary decisions based on the preceding processing, the ambiguous data, and any other pertinent information to an expert agent.

In some aspects of the present disclosure, a large language model (LLM) orchestrator is provided as an intermediary between the decision ML model and the expert agent that arranges the information provided by the decision ML model in a format that enhances readability by the expert agent. Additionally, the LLM orchestrator may be trained to evaluate the analysis of the ambiguous data provided by the expert agent to determine if the feedback fully and appropriately addresses the ambiguity so that the decision ML model can complete the processing of the data and arrive at an accurate final decision. Feedback by the expert agent that does not address the ambiguity is returned to the expert agent by the LLM orchestrator for further evaluation. The evaluation performed by the LLM orchestrator, to determine if the feedback is adequate for the decision ML model to resolve the ambiguity, requires complex analysis of the data and feedback. Moreover, such an analysis may be time prohibitive for an individual to perform, and thus impractical for an individual to perform manually, within the time frame that a decision would need to be rendered.

Aspects of the present disclosure are not limited to risk determinations, but rather can be applied to any decision data processing where the data is processed to obtain a binary result.

### Example Decision ML Model-based System for Resolving Anomalies

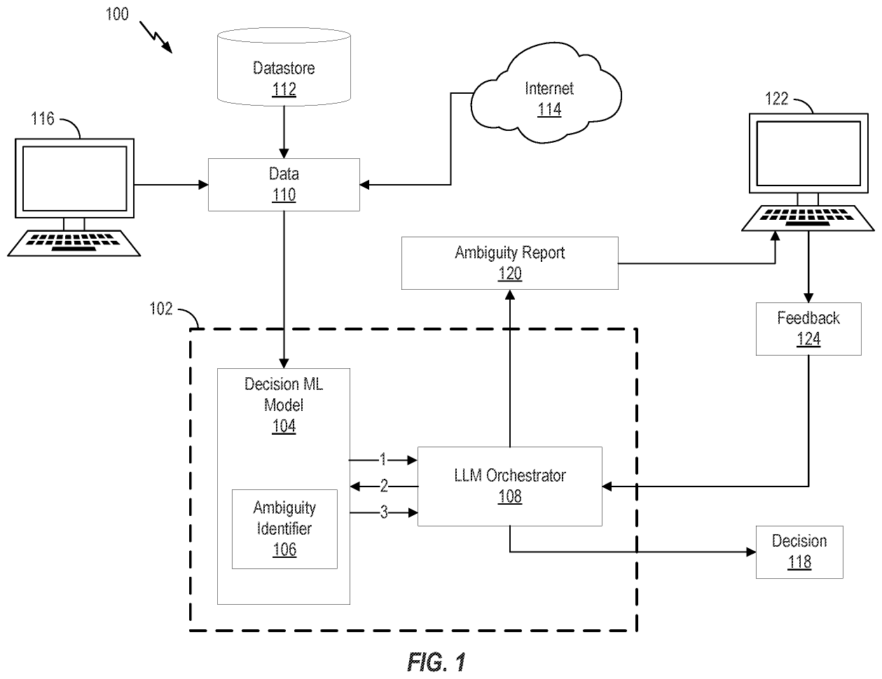

FIG. 1 illustrates a decision ML-based system 100 trained to process data 110 and render a decision 118 (e.g., a binary decision in this example) based on the data 110. The data 110 may be, for example, related to cyber-security, banking transactions (e.g., payment transactions, payment onboarding, payment monitoring, money funding, and automated clearing house (ACH) transactions), investment performance, etc. In some embodiments, the decision 118 rendered by the ML-based system 100 may be a risk assessment.

As shown in FIG. 1 the system 100 includes one or more servers 102 collectively hosting a decision ML model 104. The decision ML model 104 is provided with an ambiguity detector 106. Additionally, the one or more servers 102 includes an LLM orchestrator 108. The decision ML model 104 and LLM orchestrator 108 are shown as being hosted on a single server 102, however, the decision ML model 104 and LLM orchestrator 108 may be hosted on separate servers 102, as well as other types of electronic devices, that are in electronic communication. In some embodiments, the decision ML model 104 may be distributed across multiple servers 102 or other electronic devices.

The decision ML model 104 may obtain data 110 from multiple sources, such as a datastore 112, the Internet 114, user terminal 116 (e.g., laptop computer, desktop computer, mobile device, point-of-sale (POS) devices), electronic locks, video feeds, and other data sources depending on the particular application of the decision ML model 104. For example, in embodiments where the decision ML model is tasked with deciding if an account activity is fraudulent, the data 110 may be financial data, such as customer credit card activity, bank account activity, POS activities, and other relevant financial activities.

The decision ML model 104 processes the data 110 to identify, for example, an activity that may be fraudulent. When a decision (for example, Yes the activity is fraudulent, or No the activity is not fraudulent) is reached by the decision ML model 104, the result is provided to the LLM orchestrator 108 (represented by data transmission 1). The LLM orchestrator 108 formats the result from the decision ML model 104 as a decision output 118.

In some circumstances, the data being processed may include data that cannot be easily characterized by the decision ML model 104, such data, identified by the ambiguity detector 106, is termed “ambiguous data.” Since the decision ML model 104 is unable to continue to process other data until the ambiguous data is characterized, the ambiguous data along with additional supporting information, as described below, are provided to the LLM orchestrator 108 (data transmission 1). The LLM orchestrator 108 is configured to prepare, as an ambiguity report 120, the ambiguous data and supporting information for review by an expert agent. The ambiguity report 120 is transmitted to a workstation 122 of the expert agent. A completed evaluation of the ambiguous data is transmitted, as feedback 124, from the workstation 122 to the LLM orchestrator 108. The LLM orchestrator 108 analyzes the feedback 124 and determines if the feedback 124 resolves the ambiguity. Feedback 124 that resolves the ambiguity is provided to the decision ML model 104 (data transmission 2) so that the remaining data can be processed to arrive at a result. The decision ML model 104 can use the feedback 124 as labeled data for subsequent training, and provided to other decision ML models, as well. The result (including the data processed with the feedback) from the decision ML model 104 is provided to the LLM orchestrator 108 (data transmission 3) to format for output as the decision output 118.

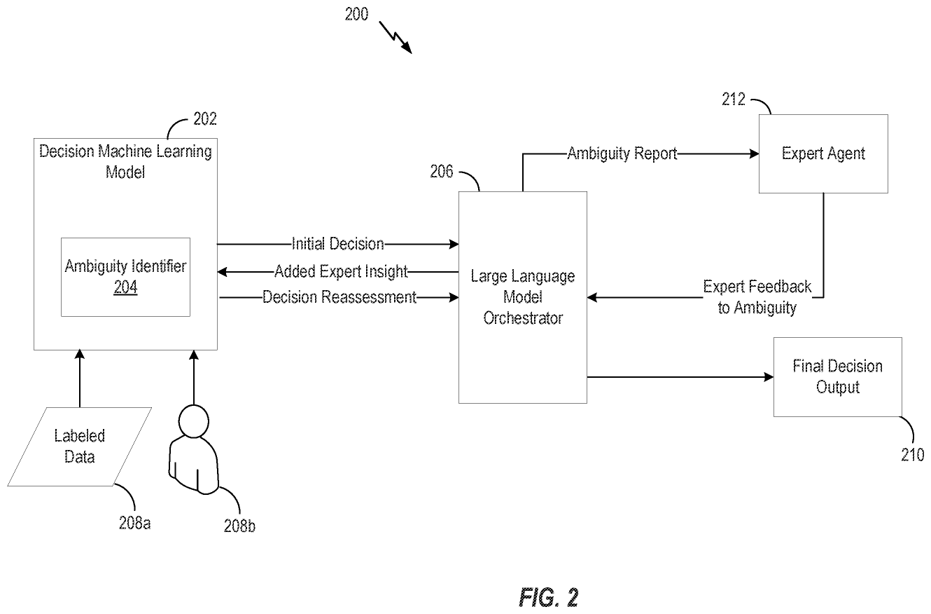

FIG. 2 illustrates a block representation of a decision ML system 200 with corresponding data flows, in accordance with aspects of the present disclosure. The ML system 200 includes a decision ML model 202 with an ambiguity identifier 204. The decision ML model 202 receives data, either labeled data 208a, during a model training phase, or live data 208b during a model deployment phase. The labeled data 208a includes data and characterizations representing a wide range of use cases encountered in the particular field to which the decision ML model 202 is applied. During the deployment phase of the decision ML model 202, live data 208b from various sources, for example, POS devices, online transactions, automated teller machines (ATMs), etc. for credit card detection.

While the majority of data received by the decision ML model 202 can be readily characterized, the decision ML model 202 may encounter data that cannot be characterized (e.g., ambiguous data) by the decision ML model 202 as trained. The decision ML model 202 may not be able to continue evaluating the remaining data to arrive at a final decision. The ambiguity identifier 204 identifies this ambiguous data and collects additional information useful for evaluating the ambiguous data. Additionally, the ambiguity identifier 204 generates a record of the previous processing performed by the decision ML model 202 up to a point when the ambiguous data is encountered. The ambiguous data, additional information, and the record of previous processing performed on the input data, are referred herein as “ambiguity evaluation information”.

The ML system 200 also includes an LLM orchestrator 206. The LLM orchestrator 206 receives outputs from the decision ML model 202 and provides the decision ML model 202 with expert insight based on the ambiguity evaluation information. For example, the decision ML model 202 may provide an initial decision to the LLM orchestrator 206 upon completing an evaluation. When the decision ML model 202 encounters ambiguous data, ambiguity evaluation information (also referred to as “ambiguity information”) is provided to the LLM orchestrator 206. Also, once the decision ML model 202 has received expert insights and evaluated the ambiguous data using the expert insights, the decision ML model 202 sends a decision reassessment to the LLM orchestrator 206. The LLM orchestrator 206 is trained to receive the initial decision, ambiguity evaluation information, and decision reassessment as input prompts. The LLM orchestrator 206 responds to the input prompts by generating an output in an appropriate format. For example, an initial decision or decision reassessment, may be output as a final decision 210 formatted as human-readable output. In other embodiments, the initial decision or decision reassessment may be output as a final decision 210 formatted as computer-readable output.

In some embodiments, the final decision 210 may be output to a fraud and risk services system. In cases where the decision ML model is evaluating consumer financial fraud, for example, the final decision 210 may be used by the fraud and risk services system to either allow or deny a fanatical transaction. In a case where the decision ML model is evaluating cybersecurity breaches, for example, the final decision 210 may be used by the fraud and risk services system to lock an account and/or notify a security specialist for further action. Aspects of the present disclosure are not limited to the examples described herein nor are aspects of the present disclosure limited to fraud and risk determinations. Other applications of aspects of the present disclosure can be realized without deviating from the scope of the present disclosure.

The LLM orchestrator 206 may be trained to generate an ambiguity report from a received ambiguity evaluation information, the ambiguity report may be formatted in a human accessible form that is evaluated by an expert agent 212. The expert agent 212 evaluates the ambiguity report to generate an expert feedback of the ambiguity data as an input prompt to the LLM orchestrator 206. The LLM orchestrator 206 evaluates the expert feedback to determine if the expert feedback adequately addresses the ambiguity data. In some embodiments, the LLM orchestrator 206 may be prompted to compare the expert feedback against the ambiguity identified by the decision ML model 202. Expert feedback that addresses the ambiguity data is formatted as an expert insight output to the decision ML model 202. As described above, the expert insight is applied by the decision ML model 202 to evaluate the ambiguity data and complete processing the data to arrive at a decision (e.g., decision reassessment). In some embodiments the expert insight is formatted by the LLM orchestrator as labeled data 208a that may be provided as training data to other decision ML models as well to further refine the decision ML models.

### Example Methods for Resolving Ambiguities

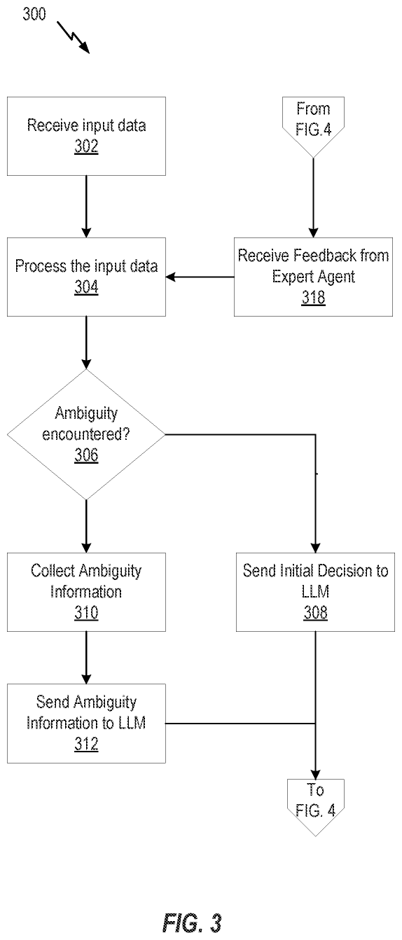

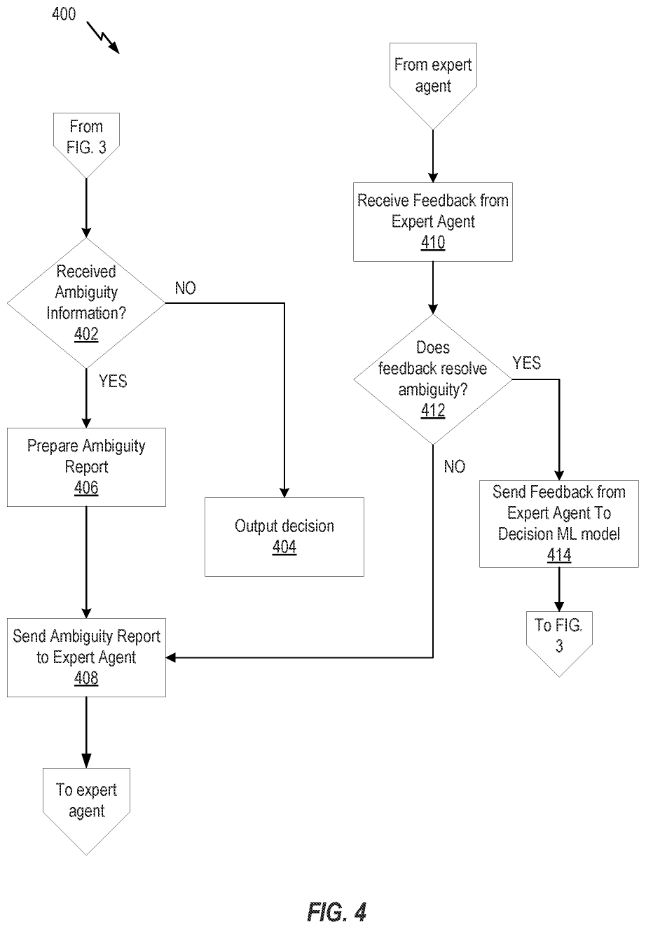

FIG. 3 and FIG. 4 illustrate a method 300 for resolving ambiguities by a decision ML model (e.g., 202 in FIG. 2). The method 300 receives input data (e.g., 208b in FIG. 2). The input data 208b in one example, may be customer credit card usage data derived from POS transactions, ATM transactions, online purchases, and related. Additionally, credit card usage data may include location information, transaction amount and time information. In another example, the input data 208b may be cybersecurity data derived from user privileges data, past login information, historical data access information, and other security related data. Some aspects of the present disclosure may be applied to any application in which a decision ML model is configured to identify events requiring human review or feedback.

At step 304, the method 300 processes the input data 208b. Specifically, the input data 208b is characterized by the decision ML model 202. For example, a decision ML model 202 trained to detect credit card fraud evaluates the input data 208b to determine if a current transaction is a potential fraud event or an authorized event.

At step 306 the method 300 determines if an ambiguity is encountered. Step 306 of method 300 may, in some embodiments, be performed by the decision ML model 202 simultaneously with step 304. Thus, during the processing of the input data 208b, if the decision ML model 202 identifies an ambiguity by operation of the ambiguity identifier 204, then the method 300 proceeds to step 310. However, if processing the input data 208b is completed without encountering an ambiguity, then the method 300 proceeds to step 308. An ambiguity may be identified using reason codes created using Shapley values, and counterfactual explanations. Counterfactual Explanation and Shapley values represent “what if” scenarios that provide insights on what are the “minimal” changes required on the model inputs to reverse a model decision (e.g., from funds being held, to funds being released to the customer). In some embodiments, the method 300 may consider factors such as days since a transaction decline was observed for a particular merchant, processing volume for the merchant, and how long the merchant has been in business. In other embodiments, method 300 may consider factors such as a high payment volume growth anomalies, and total amount of declined transactions in the last 30 days. Each factor may be assigned a different weighting.

At step 308, the method 300 sends the results of the completed processing of the input data 206b to an LLM orchestrator (e.g., 206 in FIG. 2) as an initial decision.

As described above, the method 300 proceeds to step 310 when an ambiguity is identified by the ambiguity identifier 204 of the decision ML model 202. At step 310 the method 300 collects ambiguity information. Once the ambiguity information is collected, the method 300 proceeds to step 312.

At step 312 the method 300 sends the collected ambiguity information to the LLM orchestrator 206. The ambiguity information may include ambiguous data, additional information related to the ambiguous data, and a record of previous processing performed by the decision ML model 202.

Method 300 proceeds from either step 308 or step 312 to step 402 of the LLM orchestrator 206 method 400.

Turning now to FIG. 4, at step 402 the method 400 determines if a received input prompt is ambiguity information from step 312 or an initial decision from step 308. When the LLM orchestrator 206 determines that the input prompt is an initial decision, the method 400 proceeds to step 404.

At step 404, the method 400 generates an output decision (e.g., final decision 210 at FIG. 2). The output decision may be format by the LLM orchestrator 206 as a human-readable output or as a computer-readable output. In some embodiments, the method 400 may instruct the LLM orchestrator 206 to present the output decision as a text message to a user. In some embodiments the method 400 may instruct the LLM orchestrator 206 to present the output decision 210 as an audio message provided to a user as a telephone message.

When the LLM orchestrator 206 determines that the input prompt is ambiguity information, the method 400 proceeds to step 406. At step 406, the method 400 prepares an ambiguity report (e.g., 120 at FIG. 1). The ambiguity report 120 is prepared based on the received ambiguity information and formatted for evaluation by an expert agent (e.g., 212 in FIG. 2).

At step 408, the method 400 sends the ambiguity report 120 to the expert agent 212. Once the expert agent 212 has completed evaluation of the ambiguity report 120, the expert agent 212 prepares feedback (e.g., 124 at FIG. 1). The feedback 124 is transmitted to the LLM orchestrator 206.

At step 410, the method 400 receives the feedback 124 from the expert agent 212.

At step 412, the method determines whether the feedback 124 received from the expert agent 212 addresses the ambiguity sufficiently to allow the decision ML model 202 to resolve the ambiguity and arrive at a decision. Determining that the feedback 124 does not adequately address the ambiguity causes the method 400 to returns to step 410, where the LLM orchestrator 206 resubmits the ambiguity report 120 to the expert agent 212 for reevaluation. Determining that the feedback 124 does adequately address the ambiguity causes the method 400 to proceed to step 414.

At step 414, the method 400 sends the feedback 124 as an input to the decision ML model 202. Returning to FIG. 3, at step 318, the method 300 receives the feedback 124 from the expert agent 212 by way of the LLM orchestrator 206. The feedback 124 is used by the decision ML model 202 to continue processing the input data at step 304. The decision ML model 202 continues with method 300 from steps 308 through 312, as described above, until an initial decision is generated at step 308. The initial decision sent by the decision ML model 202 to the LLM orchestrator 206, at step 308, proceeds through steps 402 and 404 of method 400 as described above.

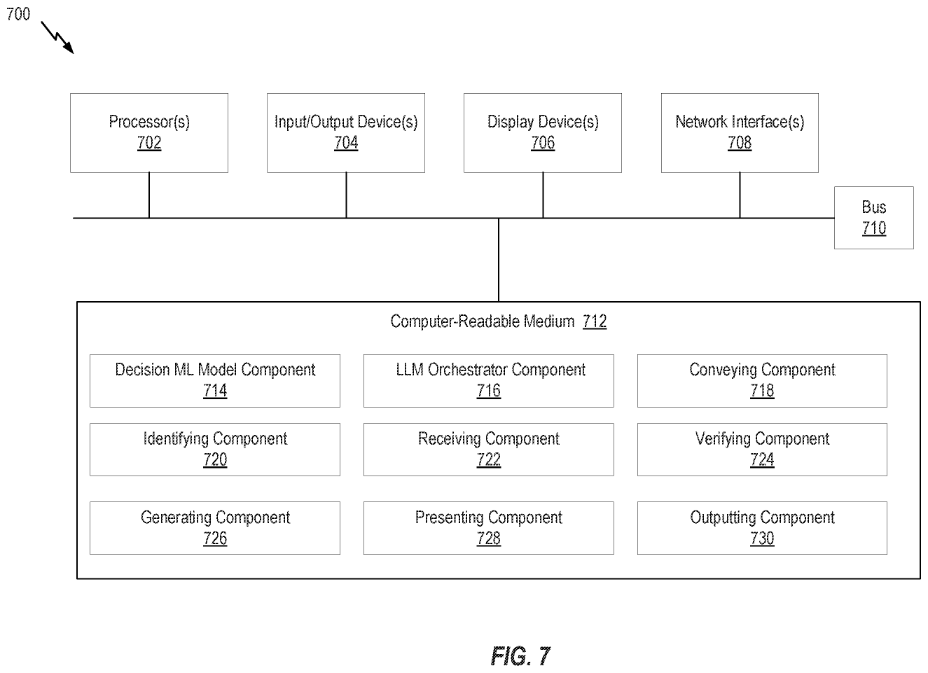

In some embodiments, methods 300 and 400 may be performed by an apparatus, such as processing system 700 of FIG. 7. Note that FIGS. 3 and 4 represent just one example of a method, and other methods including fewer, additional, or alternative steps are possible consistent with this disclosure.

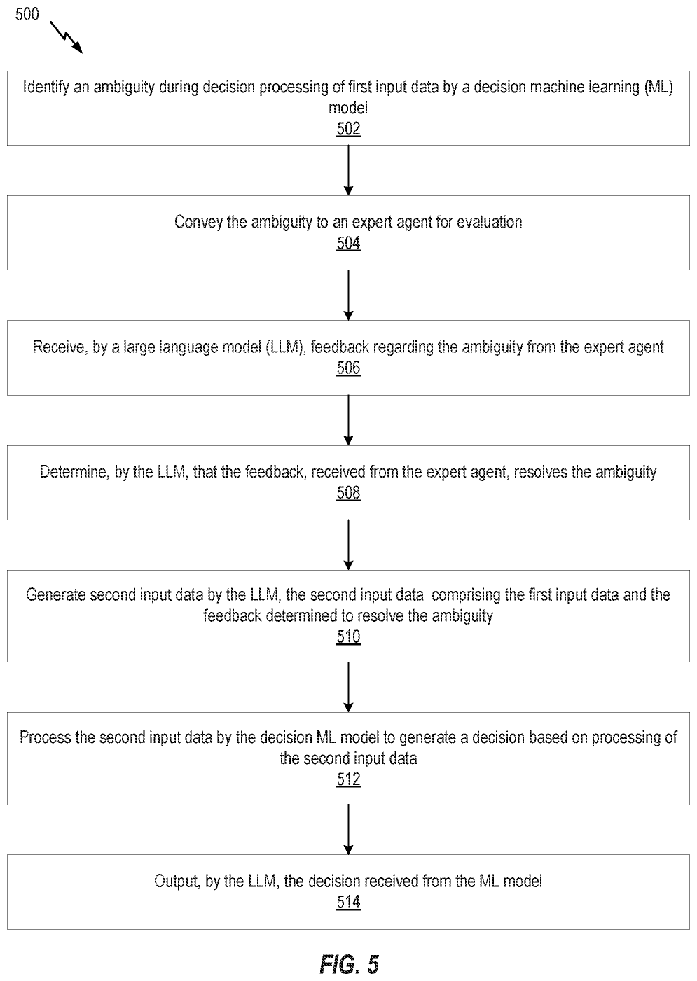

FIG. 5 illustrates a method 500 for resolving ambiguities encountered by a decision ML model (e.g., 202 in FIG. 2) while processing input data (e.g., live data 208b in FIG. 2).

At step 502, the method 500 identifies an ambiguity during decision processing of first input data by the decision ML model 202. The ambiguity may be identified using reason codes and counterfactual explanations. (e.g., from funds being held, to funds being released to the customer). In some embodiments, the method 500 may consider factors such as days since a transaction decline was observed for a particular merchant, processing volume for the merchant, and how long the merchant has been in business. In other embodiments, method 500 may consider factors such as a high payment volume growth anomalies, and total amount of declined transactions in the last 30 days. Each factor may be assigned a different weighting.

At step 504, the method 500 conveys the ambiguity to an expert agent (e.g., 212 in FIG. 2) for evaluation. At step 504, the method 500 may, in some embodiments, instruct the decision ML model to transmit ambiguity-related information to an LLM (e.g., LLM orchestrator 206 in FIG. 2); and instruct the LLM to process the ambiguity-related information to provide an ambiguity report (e.g., 120 in FIG. 1) in a human readable format to the expert agent. In some embodiments, the ambiguity report may include a description of the ambiguity; and a summary of analysis performed on the first input data by the decision ML model prior to detection of the ambiguity.

At step 506, the method 500 receives, by the LLM, feedback (e.g., 124 in FIG. 1) regarding the ambiguity from the expert agent.

At step 508, the method 500 determines, by the LLM, that the feedback, received from the expert agent, resolves the ambiguity. In some embodiments, at step 508, the method 500 instructs the LLM to verify that the feedback provides data that resolves the ambiguity. In some embodiments, at step 508, the method 500 instructs the LLM to verify that the feedback fails to resolve the ambiguity; and notify the expert agent that additional insight is needed.

At step 510, the method 500 generates second input data (e.g., expert insight in FIG. 2) by the LLM, the second input data having the first input data and the feedback determined to resolve the ambiguity. In some embodiments, at step 510 the method 500 transforms the feedback determined to resolve the ambiguity into a transformed feedback configured as an input for processing by the decision ML model. Additionally, at step 510 the method 500 may combine the transformed feedback with the first input data to form the second input data. Also, at step 510 the method 500 may provide the second input data to the decision ML model.

At step 512, the method 500 processes the second input data by the decision ML model to generate a decision (e.g., decision reassessment) based on processing of the second input data.

At step 514, the method 500 outputs the decision (e.g., 210 in FIG. 2) received from the decision ML model.

In some embodiments, method 500 may be performed by an apparatus, such as processing system 700 of FIG. 7. Note that FIG. 5 is just one example of a method, and other methods including fewer, additional, or alternative steps are possible consistent with this disclosure.

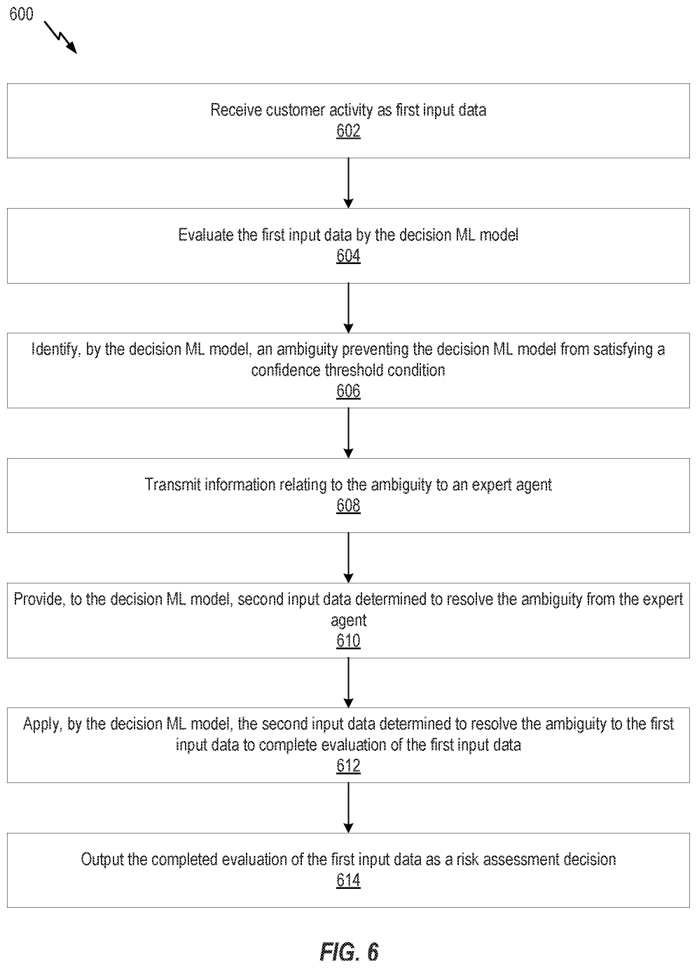

FIG. 6 illustrates an example use case in which a method 600 provides a risk assessment of customer activity. Customer activity may, in some embodiments, include credit card activity. In other embodiments, customer activity may include online payment activity.

At step 602, the method 600 to receive customer activity as first input data.

At step 604, the method 600 evaluates the first input data (e.g., 208b in FIG. 2) by the decision ML model (e.g., 202 in FIG. 2).

At step 606, the method 600 identifies an ambiguity preventing the decision ML model from satisfying a confidence threshold condition. The ambiguity may be identified using reason codes, and counterfactual explanations. In some embodiments, the method 600 may consider factors such as days since a transaction decline was observed for a particular merchant, processing volume for the merchant, and how long the merchant has been in business. In other embodiments, method 600 may consider factors such as a high payment volume growth anomalies, and total amount of declined transactions in the last 30 days. Each factor may be assigned a different weighting.

At step 608, the method 600 transmits information relating to the ambiguity to an expert agent (e.g., 212 in FIG. 2). In some embodiments, at step 608 the method 600 may sends ambiguity-related information to an LLM (e.g., LLM orchestrator 206 in FIG. 2). Additionally, at step 608, the method 600 may process the ambiguity-related information, by the LLM, to provide an ambiguity report (e.g., 120 in FIG. 1) in a human readable format; and transmit the ambiguity report to the expert agent. The ambiguity report may, in some embodiments, include a description of the ambiguity, and a summary of analysis performed on the first input data by the decision ML model prior to detection of the ambiguity.

At step 610, the method 600 provides, from the LLM to the decision ML model, second input data determined to resolve the ambiguity from the expert agent. In some embodiments, the method 600, at step 610, receives, by the LLM, feedback (e.g., 124 in FIG. 1) from the expert agent; verifies that the feedback provides data that resolves the ambiguity; transforms the feedback verified to resolve the ambiguity into the second input data for the decision ML model; and transmits, to the decision ML model, the second input data. In some embodiments at step 610, the method 600 receives, by the LLM, the feedback from the expert agent; verifies that the feedback fails to resolve the ambiguity; and notifies the expert agent that additional insight is needed.

At step 612, the method 600 applies the second input data determined to resolve the ambiguity to the first input data to complete evaluation of the first input data.

At step 614, the method 600 outputs the completed evaluation of the first input data as a risk assessment decision (e.g., final decision 210 in FIG. 2) by way of the LLM 206.

In some embodiments, method 600 may be performed by an apparatus, such as processing system 700 of FIG. 7. Note that FIG. 6 is just one example of a method, and other methods including fewer, additional, or alternative steps are possible consistent with this disclosure.

### Example Processing System for Resolving Ambiguities

FIG. 7 depicts an example processing system 700 configured to perform various aspects described herein, including, for example, method 300 as described above with respect to FIG. 3, method 400 as described above with respect to FIG. 4, method 500 as described above with respect to FIG. 5 and method 600 as described above with respect to FIG. 6.

Processing system 700 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 700 includes one or more processors 702, one or more input/output devices 704, one or more display devices 706, and one or more network interfaces 708 through which processing system 700 is connected to one or more networks (e.g., a local network, an intranet, the Internet, or any other group of processing systems communicatively connected to each other), and computer-readable medium 712.

In the depicted example, the aforementioned components are coupled by a bus 710, which may generally be configured for data and/or power exchange amongst the components. Bus 710 may be representative of multiple buses, while only one is depicted for simplicity.

Processor(s) 702 are generally configured to retrieve and execute instructions stored in one or more memories, including local memories like the computer-readable medium 712, as well as remote memories and data stores. Similarly, processor(s) 702 are configured to retrieve and store application data residing in local memories like the computer-readable medium 712, as well as remote memories and data stores. More generally, bus 710 is configured to transmit programming instructions and application data among the processor(s) 702, display device(s) 706, network interface(s) 708, and computer-readable medium 712. In certain embodiments, processor(s) 702 are included to be representative of a one or more central processing units (CPUs), graphics processing unit (GPUs), tensor processing unit (TPUs), accelerators, and other processing devices.

Input/output device(s) 704 may include any device, mechanism, system, interactive display, and/or various other hardware components for communicating information between processing system 700 and a user of processing system 700. For example, input/output device(s) 704 may include input hardware, such as a keyboard, touch screen, button, microphone, and/or other device for receiving inputs from the user. Input/output device(s) 704 may further include display hardware, such as, for example, a monitor, a video card, and/or other another device for sending and/or presenting visual data to the user. In certain embodiments, input/output device(s) 704 is or includes a graphical user interface.

Display device(s) 706 may generally include any sort of device configured to display data, information, graphics, user interface elements, and the like to a user. For example, display device(s) 706 may include internal and external displays such as an internal display of a tablet computer or an external display for a server computer or a projector. Display device(s) 706 may further include displays for devices, such as augmented, virtual, and/or extended reality devices.

Network interface(s) 708 provide processing system 700 with access to external networks and thereby to external processing systems. Network interface(s) 708 can generally be any device capable of transmitting and/or receiving data via a wired or wireless network connection. Accordingly, network interface(s) 708 can include a communication transceiver for sending and/or receiving any wired and/or wireless communication. For example, Network interface(s) 708 may include an antenna, a modem, a LAN port, a Wi-Fi card, a WiMAX card, cellular communications hardware, near-field communication (NFC) hardware, satellite communication hardware, and/or any wired or wireless hardware for communicating with other networks and/or devices/systems. In certain embodiments, network interface(s) 708 includes hardware configured to operate in accordance with the Bluetooth® wireless communication protocol.

Computer-readable medium 712 may be a volatile memory, such as a random access memory (RAM), or a nonvolatile memory, such as nonvolatile random access memory, phase change random access memory, or the like. In this example, computer-readable medium 712 includes a decision ML model component 714 (e.g., decision ML model 202 in FIG. 2), an LLM orchestrator component 716 (e.g., LLM orchestrator 206 in FIG. 2), a conveying component 718 (e.g., decision ML model 202 in FIG. 2), an identifying component 720, a receiving component 722, a verifying component 724, a generating component 726, a processing component 728, and an outputting component 730.

In certain embodiments, the decision ML model component 714 is configured to receive input data, such as live data 208b in FIG. 2. The decision ML model component 714 evaluates the input data (e.g., live data 208b) to generate a decision, such as the initial decision of method 300 and described above with respect to FIG. 3. Additionally, the decision ML model component 714 provides an ambiguity identifying functionality, such as ambiguity identifier 204 in FIG. 2 that identifies ambiguities (e.g., ambiguous data) during the evaluation of the input data (e.g., live data 208b). Identified ambiguities are provided to an expert agent, such as expert agent 212 in FIG. 2, by the conveying component 718.

The conveying component 718 is configured to transmit ambiguity-related information from the decision ML model component 714 to the LLM orchestrator component 716 as described above with respect to the method 300 shown in FIG. 3. Additionally, the conveying component 718 is configured to transmit feedback, such as feedback 124 as described above with respect to FIG. 1, in the form of a second input data from the LLM orchestrator component 716 to the decision ML model component 714, as described, for example, with respect to the method 400 shown in FIG. 4. The conveying component 718 may be implemented by bus 710 and network interface 708 in embodiments where the decision ML model component 714 is hosted on a first server and the LLM orchestrator component 716 is hosted on a second server. In other embodiments, where the decision ML model component 714 and the LLM orchestrator component 716 are hosted on a single server, the conveying component 718 may be implemented by computer-readable media, such as RAM, for example.

The identifying component 720 is configured to identify ambiguities occurring during processing of the input data 208b. The identifying component 720 may be implemented as an ambiguity identifier (e.g., 204 in FIG. 2) in the decision ML model component 714, as described above with respect to the method 300 shown in FIG. 3, for example. The ambiguities may be identified using reason code and counterfactual explanations.

The receiving component 722 is configured receive, by the LLM orchestrator component 716, feedback 124 from the expert agent 212, as described above with respect to the method 400 shown in FIG. 4. The receiving component 722 may be implemented by bus 710 and network interface 708 where the expert agent is connected to the processing system 700 by way a remote user terminal (e.g., workstation 122 in FIG. 1). In other embodiments, the receiving component 722 may be implemented by bus 710, display device 706, and input/output devices 704.

The verifying component 724 is configured to verify that feedback 124 received from the expert agent 212 resolves the ambiguity, as in method 400 described above with respect to FIG. 4. The verifying component 724 may be implemented by functionality in the LLM orchestrator 206.

The generating component 726 is configured to generate second input data (e.g., expert insight) by the LLM orchestrator component 716, as in method 400 described above with respect to FIG. 4. The generating component 726 may be implemented as a functionality of the LLM orchestrator 206.

The processing component 728 is configured as a functionality of the decision ML model 202. The processing component 728 processes the second input data to generate a decision (e.g., decision reassessment) based on processing the second input data, as in method 300 described above with respect to FIG. 3.

The outputting component 730 is configured to output a final decision 210 by the LLM orchestrator 206, as in method 400 described above with respect to FIG. 4. The outputting component 730 may include transmitting the final decision 210 to end user view a short message system (SMS) message, an email, an audio message via a telephone or mobile device, or notifications on a user device (e.g., personal desktop computer, laptop, mobile device, etc.).

Note that FIG. 7 is just one example of a processing system consistent with aspects described herein, and other processing systems having additional, alternative, or fewer components are possible consistent with this disclosure.

### Example Clauses

Implementation examples are described in the following numbered clauses:
Clause 1: A method comprising: identifying an ambiguity during decision processing of first input data by a decision machine learning (ML) model; conveying the ambiguity to an expert agent for evaluation; receiving, by a large language model (LLM), feedback regarding the ambiguity from the expert agent; determining, by the LLM, that the feedback, received from the expert agent, resolves the ambiguity; generating second input data by the LLM, the second input data comprising the first input data and the feedback determined to resolve the ambiguity; processing the second input data by the decision ML model to generate a decision based on processing of the second input data; and outputting, by the LLM, the decision received from the ML model.
Clause 2: The method of Clause 1, wherein conveying the ambiguity to the expert agent comprises: transmitting, by the decision ML model, ambiguity-related information to the LLM; and processing, by the LLM, the ambiguity-related information to provide an ambiguity report in a human readable format.
Clause 3: The method of any one of Clause 1 or Clause 2, wherein the ambiguity report comprises: a description of the ambiguity; and a summary of analysis performed on the first input data by the decision ML model prior to detection of the ambiguity.
Clause 4: The method of any one of Clauses 1-3, wherein determining that the feedback resolves the ambiguity comprises verifying, by the LLM, that the feedback provides data that resolves the ambiguity.
Clause 5: The method of any one of Clauses 1-4, wherein determining that the feedback resolves the ambiguity comprises: verifying, by the LLM, that the feedback fails to resolve the ambiguity; and notifying the expert agent that additional insight is needed.
Clause 6: The method of any one of Clauses 1-5, wherein generating the second input data comprises: transforming the feedback determined to resolve the ambiguity into a transformed feedback configured as an input for processing by the decision ML model; combining the transformed feedback with the first input data to form the second input data; and providing to the decision ML model, the second input data from the LLM.
Clause 7: The method of any one of Clauses 1-6, wherein: the first input data comprises customer activity data, and the decision is a risk assessment of customer activity based on the customer activity data.
Clause 8: A method for providing a risk assessment of customer activity using a decision machine learning (ML) model, comprising: receiving customer activity as first input data; evaluating the first input data by the decision ML model; identifying, by the decision ML model, an ambiguity preventing the decision ML model from satisfying a confidence threshold condition; transmitting information relating to the ambiguity to an expert agent; providing, to the decision ML model, second input data determined to resolve the ambiguity from the expert agent; applying, by the decision ML model, the second input data determined to resolve the ambiguity to the first input data to complete evaluation of the first input data; and outputting the completed evaluation of the first input data as a risk assessment decision.
Clause 9: The method of Clause 8, wherein transmitting information relating to the ambiguity to the expert agent comprises: sending, by the decision ML model, ambiguity-related information to a large language model (LLM); processing, by the LLM, the ambiguity-related information to provide an ambiguity report in a human readable format; and transmitting, by the LLM, the ambiguity report to the expert agent.
Clause 10: The method of any one of Clause 8 or Clause 9, wherein the ambiguity report comprises: a description of the ambiguity; and a summary of analysis performed on the first input data by the decision ML model prior to detection of the ambiguity.
Clause 11: The method of any one of Clauses 8-10, wherein providing the second input data to the decision ML model comprises: receiving, by a large language model (LLM), the feedback from the expert agent; verifying, by the LLM, that the feedback provides data that resolves the ambiguity; transforming the feedback verified to resolve the ambiguity into the second input data for the decision ML model; and transmitting, to the decision ML model, the second input data by the LLM.
Clause 12: The method of any one of Clauses 8-11, wherein providing the second input data to the decision ML model comprises: receiving, by a large language model (LLM), the feedback from the expert agent; verifying, by the LLM, that the feedback fails to resolve the ambiguity; and notifying the expert agent that additional insight is needed.
Clause 13: The method of any one of Clauses 8-12, wherein the decision ML model identifies ambiguities based on reason code and counterfactual explanations.
Clause 14: A processing system, comprising: a memory comprising computer-executable instructions; and a processor configured to execute the computer-executable instructions and cause the processing system to perform a method in accordance with any one of Clauses 1-13.
Clause 15: A processing system, comprising means for performing a method in accordance with any one of Clauses 1-13.
Clause 16: A non-transitory computer-readable medium storing program code for causing a processing system to perform the steps of any one of Clauses 1-13.
Clause 17: A computer program product embodied on a computer-readable storage medium comprising code for performing a method in accordance with any one of Clauses 1-13.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method comprising:
identifying an ambiguity during decision processing of first input data by a decision machine learning (ML) model;
conveying the ambiguity to an expert agent for evaluation;
receiving, by a large language model (LLM), feedback regarding the ambiguity from the expert agent;
determining, by the LLM, that the feedback, received from the expert agent, resolves the ambiguity;
generating second input data by the LLM, the second input data comprising the first input data and the feedback determined to resolve the ambiguity;
processing the second input data by the decision ML model to generate a decision based on processing of the second input data; and
outputting, by the LLM, the decision received from the ML model.

2. The method of claim 1, wherein conveying the ambiguity to the expert agent comprises:
transmitting, by the decision ML model, ambiguity-related information to the LLM; and
processing, by the LLM, the ambiguity-related information to provide an ambiguity report in a human readable format.

3. The method of claim 2, wherein the ambiguity report comprises:
a description of the ambiguity; and
a summary of analysis performed on the first input data by the decision ML model prior to detection of the ambiguity.

4. The method of claim 1, wherein determining that the feedback resolves the ambiguity comprises verifying, by the LLM, that the feedback provides data that resolves the ambiguity.

5. The method of claim 1, wherein determining that the feedback resolves the ambiguity comprises:
verifying, by the LLM, that the feedback fails to resolve the ambiguity; and
notifying the expert agent that additional insight is needed.

6. The method of claim 1, wherein generating the second input data comprises:
transforming the feedback determined to resolve the ambiguity into a transformed feedback configured as an input for processing by the decision ML model;
combining the transformed feedback with the first input data to form the second input data; and
providing to the decision ML model, the second input data from the LLM.

7. The method of claim 1, wherein:
the first input data comprises customer activity data, and
the decision is a risk assessment of customer activity based on the customer activity data.

8. A processing system, comprising:
a memory comprising computer-executable instructions; and
a processor configured to execute the computer-executable instructions and cause the processing system to:
identify an ambiguity during decision processing of first input data by a decision machine learning (ML) model;
convey the ambiguity to an expert agent for evaluation;
receive, by a large language model (LLM), feedback regarding the ambiguity from the expert agent;
determine, by the LLM, that the feedback, received from the expert agent, resolves the ambiguity;
generate second input data by the LLM, the second input data comprising the first input data and the feedback determined to resolve the ambiguity;
process the second input data by the decision ML model to generate a decision based on processing of the second input data; and
output, by the LLM, the decision received from the ML model.

9. The processing system of claim 8, wherein the processor is further configured to cause the processing system to:
transmit, by the decision ML model, ambiguity-related information to the LLM; and
process, by the LLM, the ambiguity-related information to provide an ambiguity report in a human readable format.

10. The processing system of claim 9, wherein the ambiguity report comprises:
a description of the ambiguity; and
a summary of analysis performed on the first input data by the decision ML model prior to detection of the ambiguity.

11. The processing system of claim 8, wherein the processor is further configured to cause the processing system to verify, by the LLM, that the feedback provides data that resolves the ambiguity.

12. The processing system of claim 8, wherein the processor is further configured to cause the processing system to:
verify, by the LLM, that the feedback fails to resolve the ambiguity; and
notify the expert agent that additional insight is needed.

13. The processing system of claim 8, wherein the processor is further configured to cause the processing system to:
transform the feedback determined to resolve the ambiguity into a transformed feedback configured as an input for processing by the decision ML model;
combine the transformed feedback with the first input data to form the second input data; and
provide to the decision ML model, the second input data from the LLM.

14. The processing system of claim 8, wherein:
the first input data comprises customer activity data, and
the decision is a risk assessment of customer activity based on the customer activity data.

15. A method for providing a risk assessment of customer activity using a decision machine learning (ML) model, comprising:
receiving customer activity as first input data;
evaluating the first input data by the decision ML model;
identifying, by the decision ML model, an ambiguity preventing the decision ML model from satisfying a confidence threshold condition;
transmitting information relating to the ambiguity to an expert agent;
providing, to the decision ML model, second input data determined to resolve the ambiguity from the expert agent;
applying, by the decision ML model, the second input data determined to resolve the ambiguity to the first input data to complete evaluation of the first input data; and
outputting the completed evaluation of the first input data as a risk assessment decision.

16. The method of claim 15, wherein transmitting information relating to the ambiguity to the expert agent comprises:
sending, by the decision ML model, ambiguity-related information to a large language model (LLM);
processing, by the LLM, the ambiguity-related information to provide an ambiguity report in a human readable format; and
transmitting, by the LLM, the ambiguity report to the expert agent.

17. The method of claim 16, wherein the ambiguity report comprises:
a description of the ambiguity; and
a summary of analysis performed on the first input data by the decision ML model prior to detection of the ambiguity.

18. The method of claim 15, wherein providing the second input data to the decision ML model comprises:
receiving, by a large language model (LLM), a feedback from the expert agent;
verifying, by the LLM, that the feedback provides data that resolves the ambiguity;
transforming the feedback verified to resolve the ambiguity into the second input data for the decision ML model; and
transmitting, to the decision ML model, the second input data by the LLM.

19. The method of claim 15, wherein providing the second input data to the decision ML model comprises:
receiving, by a large language model (LLM), a feedback from the expert agent;
verifying, by the LLM, that the feedback fails to resolve the ambiguity; and
notifying the expert agent that additional insight is needed.

20. The method of claim 15, wherein the decision ML model identifies ambiguities based on reason code and counterfactual explanations.
